(19) United States
(12) Patent Application Publication
(10) Pub. No.: US 2021/0406685 A1
(43) Pub. Date: Dec. 30, 2021

(54) ARTIFICIAL INTELLIGENCE FOR KEYWORD RECOMMENDATION

(71) Applicant: 6SENSE INSIGHTS, INC., San Francisco, CA (US)

(72) Inventors: Dan CARMODY, Berkeley, CA (US); Yulia TYUTINA, Eden Prairie, MN (US); Michael STEVENS, San Francisco, CA (US); Aditya MAJUMDAR, San Jose, CA (US); Viral BAJARIA, San Francisco, CA (US); Steven SASSAMAN, San Francisco, CA (US)

(21) Appl. No.: 17/362,646

(22) Filed: Jun. 29, 2021

Related U.S. Application Data
(60) Provisional application No. 63/045,693, filed on Jun. 29, 2020.

(51) Int. Cl. G06N 3/08; G06N 3/04; G06Q 30/02

(52) U.S. Cl. CPC G06N 3/08; G06Q 30/0201; G06N 3/04

(57) ABSTRACT

Artificial intelligence for keyword recommendations. In an embodiment, raw keyword data are received. The raw keyword data comprise keyword activity records that each comprises a uniform resource locator (URL) for an online resource and metadata for the online resource. Arrays of keywords are extracted from the keyword activity records, with each array of keywords associated with the URL in the keyword activity record from which the array of keywords was extracted. User-specified keyword(s) are received, and a subset of the arrays of keywords that match at least one of the user-specified keyword(s) is identified. A training dataset is generated from the subset, and used to train a machine-learning model to output recommended keywords based on an input keyword.

### CROSS-REFERENCE TO RELATED APPLICATIONS

This application claims priority to U.S. Provisional Patent App. No. 63/045,693, filed on Jun. 29, 2020, which is hereby incorporated herein by reference as if set forth in full.

In addition, this application is related to U.S. Pat. No. 9,202,227 (227 patent), issued on Dec. 1, 2015, U.S. Pat. No. 10,475,056 (056 patent), issued on Nov. 12, 2019, and U.S. Pat. No. 10,536,427 (427 patent), issued on Jan. 14, 2020, which are all hereby incorporated herein by reference as if set forth in full. This application is also related to U.S. Provisional Patent App. No. 63/045,731, filed on Jun. 29, 2020, and U.S. Provisional Patent App. No. 63/045,707, filed on Jun. 29, 2020, which are both hereby incorporated herein by reference as if set forth in full.

### BACKGROUND

### Field of the Invention

The embodiments described herein are generally directed to artificial intelligence, and, more particularly, to a machine-learning model for providing keyword recommendations.

### Description of the Related Art

The ability to select proper keywords is essential to any keyword-based search. The selection of the wrong keywords will typically produce irrelevant results. Naturally, the keywords that are selected for a search should be, by definition, “key” to the search. This means that, statistically, a selected keyword should occur in a target more frequently than would be expected by chance alone. This holds true for any type of keyword-based search.

In one particular context, the selection of the proper keywords can be advantageous when attempting to predict buying intent, for example, of visitors to a web site, as described for example in the '227 patent and the '056 patent. In this context, a buying intent for a particular product (e.g., good or service) can be inferred from the presence of keywords, related to that product, in a search query, or webpage or other online document visited by a prospective customer. To accurately measure buying intent, it is important that inferences of buying intent be based on the most relevant keywords.

In another particular context, marketers can link their products to particular keywords input into a search engine. When a user queries the search engine using particular keywords, the search engine may return sponsored results or advertisements from the marketers linked to those particular keywords. Thus, to ensure cost-effective search engine marketing (SEM), it is important for marketers to select the most relevant keywords to their products.

### SUMMARY

Accordingly, systems, methods, and non-transitory computer-readable media are disclosed for a machine-learning model that provides keyword recommendations. In an embodiment, a method is disclosed that comprises using at least one hardware processor to: receive raw keyword data comprising a plurality of keyword activity records, wherein each of the plurality of keyword activity records comprises a uniform resource locator (URL) for an online resource and metadata for the online resource; generate a plurality of arrays of keywords by extracting an array of keywords from each of the plurality of keyword activity records, wherein each of the plurality of arrays of keywords is associated with the URL in the keyword activity record from which the array of keywords was extracted; receive one or more user-specified keywords; identify a subset of the plurality of arrays of keywords that match at least one of the one or more user-specified keywords; generate a training dataset from the subset of the plurality of arrays of keywords; and use the training dataset to train a machine-learning model to output recommended keywords based on an input keyword.

Training the machine-learning model may comprise training one or more neural networks to convert keywords in the training dataset to points in a multi-dimensional vector space in which a distance between two points represents a degree of similarity between keywords at those two points, such that a shorter distance represents a higher degree of similarity and a larger distance represents a lower degree of similarity. Each point may comprise a vector of numbers. The distance may be a Euclidean distance. The multi-dimensional vector space may comprise at least one-hundred dimensions.

Identifying a subset of the plurality of arrays of keywords that match at least one of the one or more user-specified keywords may comprise, for each of the plurality of arrays of keywords and for each of the one or more user-specified keywords: comparing the array of keywords to the user-specified keyword; when the array of keywords comprises the user-specified keyword, determining that the array of keywords matches the user-specified keyword; and, when the array of keywords does not comprise the user-specified keyword, when the user-specified keyword comprises two or more words and the array of keywords comprises all of the two or more words, determining that the array of keywords matches the user-specified keyword regardless of an arrangement of the two or more words in the array of keywords, and, when the user-specified keyword consists of a single word or when the user-specified keywords comprises two or more words and the array of keywords does not comprise all of the two or more words, determining that the array of keywords does not match the user-specified keyword.

Extracting an array of keywords from each of the plurality of keyword activity records may comprise, for each of the plurality of keyword activity records, extracting one or more keywords from the metadata in the keyword activity record. Extracting an array of keywords from each of the plurality of keyword activity records may further comprise, for each of the plurality of keyword activity records, extracting one or more keywords from the URL in the keyword activity record. Extracting one or more keywords from the URL may comprise splitting the URL into two or more keywords based on one or more delimiter symbols.

The method may further comprise using the at least one hardware processor to: receive at least one keyword from a user; apply the machine-learning model to the at least one keyword to output one or more recommended keywords; and provide the one or more recommended keywords to the user. The method may further comprise using the at least one hardware processor to: receive a selection of at least one of the one or more recommended keywords from the user; and add the selected at least one recommended keyword to the one or more user-specified keywords. The method may further comprise using the at least one hardware processor to: generate a graphical user interface comprising at least one screen, wherein the at least one screen comprises a first frame comprising a visual representation of each of the one or more user-specified keywords, and a second frame comprising a selectable visual representation of each of the one or more recommended keywords; and wherein receiving a selection of at least one of the one or more recommended keywords from the user comprises receiving a selection of the selectable visual representation of that at least one recommended keyword in the second frame; and wherein adding the selected at least one recommended keyword to the one or more user-specified keywords comprises adding a visual representation of the at least one recommended keyword to the first frame.

Generating a training dataset from the subset of the plurality of arrays of keywords may comprise normalizing one or more keywords in the subset of the plurality of arrays of keywords. Normalizing one or more keywords may comprise removing spaces from any keywords in the subset of the plurality of arrays of keywords that comprise multi-word phrases. The method may further comprise using the at least one hardware processor to, when normalizing the one or more keywords, generate a look-up dictionary that, for each of the normalized one or more keywords, maps a normalized version of that keyword to an un-normalized version of that keyword. The method may further comprise using the at least one hardware processor to: apply the machine-learning model to at least one input keyword to output the normalized version of each of one or more recommended keywords; use the look-up dictionary to retrieve the un-normalized version of each of the one or more recommended keywords; and provide the un-normalized version of each of the one or more recommended keywords to a user.

The method may further comprise using the at least one hardware processor to: rank the URLs that are associated with the subset of the plurality of arrays of keywords based on, for each array of keywords in the subset of the plurality of arrays of keywords, an average frequency of keywords in that array of keywords, relative to a corpus, and a fraction of keywords in that array of keywords that matched at least one of the one or more user-specified keywords; and determine a relevant subset of the URLs based on the ranking. The method may further comprise using the at least one hardware processor to: associate each of the plurality of keyword activity records to a company that corresponds to a visit to the URL in that keyword activity record; and, for each company that corresponds to a visit to one or more URLs in the relevant subset of the URLs, apply a predictive intent model to the one or more URLs to predict a likelihood that the company intends to purchase a product.

Any of the disclosed methods may be embodied in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates an example flow diagram for a data pipeline that utilizes keyword recommendation, according to an embodiment;

FIG. 4 illustrates an example of a screen of a graphical user interface for providing recommended keywords, according to an embodiment; and

FIG. 5 illustrates an example of a screen of a graphical user interface for providing top keywords, according to an embodiment.

### DETAILED DESCRIPTION

In an embodiment, systems, methods, and non-transitory computer-readable media are disclosed for a machine-learning model that provides keyword recommendations. Keyword research forms an important part of the “dark funnel” of the business-to-business (B2B) purchase process, capturing early-stage signs of purchase intent. Disclosed embodiments collect (e.g., from a plurality of third-party sources) and process (e.g., filter) data, representing intent-related activities and comprising keywords, expand the coverage and quantity of keyword intent data (e.g., via a recommendation model), enhance the quality of keyword intent data (e.g., via a relevance-based ranking formula), and utilize the expanded and enhanced keyword intent data to drive downstream functions, such as predictive signals (e.g., B2B purchase intent, tied to specific companies). For example, a keyword-recommending model may suggest new keywords based on keywords in a user's website, SEM keywords, keywords used in engagements by a user's customers or prospective customers, and/or keywords in a past pipeline that led to successful purchases, to help find more relevant keywords, provide sales intelligence, perform more efficient advertising, email marketing, and other sales outreach, and/or the like. The keyword-recommending model can help B2B teams find more customers with relevant behaviors.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

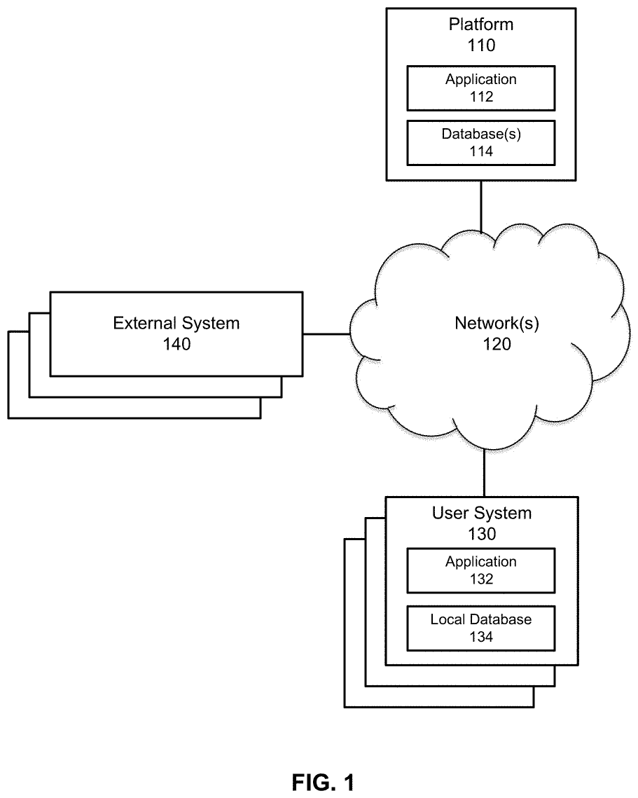

FIG. 1 illustrates an example infrastructure in which the disclosed processes may operate, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, in general, it is contemplated that user system(s) 130 would comprise the device on which a user (e.g., sales or marketing representative of an enterprise) typically performs his or her work, such as a workstation, desktop computer, laptop computer, tablet computer, and/or mobile device (e.g., smart phone).

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™ IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 (which may utilize a local database 134) executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application is a browser application, which simply requests, receives, and renders webpages at user system(s) 130, while the server application on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the functions, processes, or methods of the application described herein.

1.2. Example Processing Device

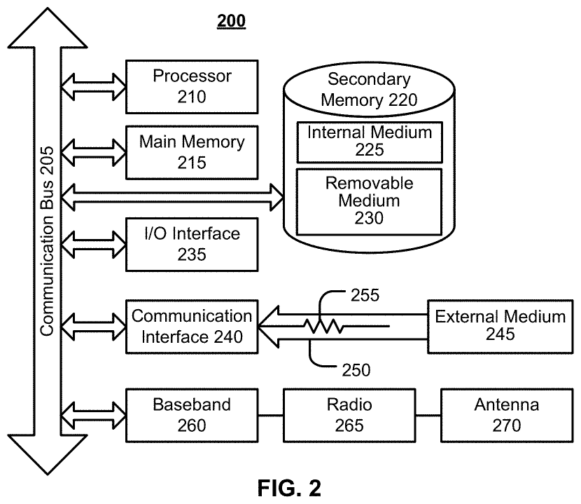

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

Secondary memory 220 is a non-transitory computer-readable medium having computer-executable code (e.g., disclosed software modules) and/or other data stored thereon. The computer software or data stored on secondary memory 220 is read into main memory 215 for execution by processor 210.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed application, or software modules) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

2. Process Overview

Embodiments of processes for a machine-learning model that provides keyword recommendations will now be described in detail. It should be understood that the described processes may be embodied in one or more software modules that are executed by one or more hardware processors (e.g., processor 210), e.g., as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

2.1. Overall Process

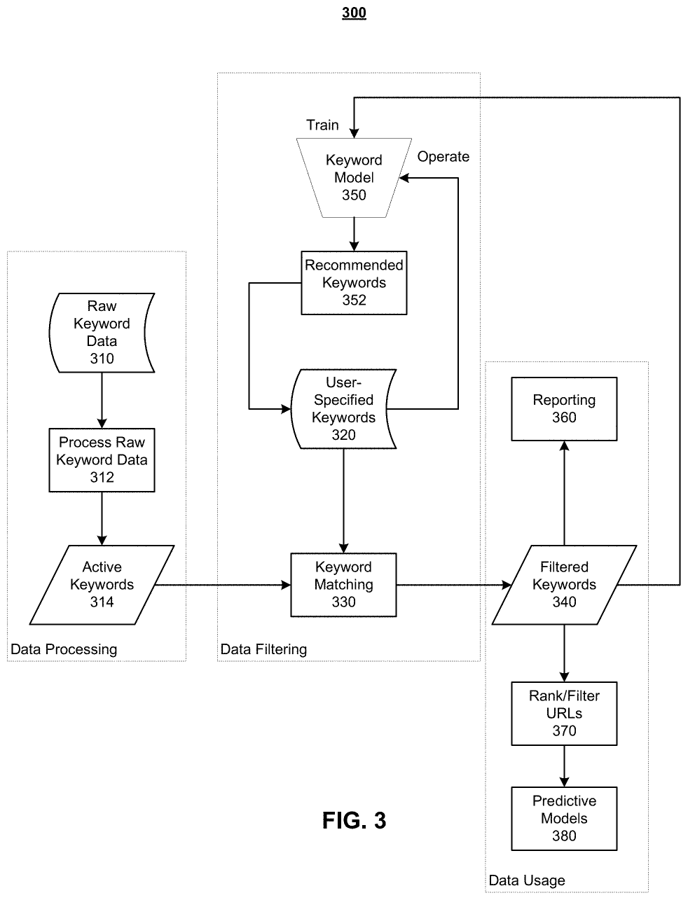

FIG. 3 illustrates an overall data flow for a process 300 in which keyword recommendation may be used, according to an embodiment. Process 300 may be implemented by server application 112 and/or client application 132, and executed by processor(s) 210 of platform 110 and/or user system 130. As used herein, the term “keyword” may refer to both a single word and a multi-word phrase comprising two or more words. For example, keywords may include both the term “cloud” and the term “cloud based computing”.

Raw keyword data 310 may be received from one or more data sources, such as external system(s) 140 (e.g., data vendors). In an embodiment, raw keyword data 310 may comprise a plurality of keyword activity records representing activity for a plurality of online resources that have or utilize keywords. Raw keyword data 310 may represent the online activity of one or a plurality of visitors that interacted with these online resources, with each of the plurality of keyword activity records representing one visit to one online resource. The online resources may be search queries, search results, webpages, electronic documents, and/or the like. Raw keyword data 310 may comprise, for each of the plurality of keyword activity records, the Uniform Resource Locator (URL) of the online resource represented by the keyword activity record, the IP address of the visitor to that online resource, the date of the visit (e.g., timestamp), metadata for the online resource (e.g., keywords embedded in the HTML, source code of a webpage or in a search query, including a title, description, explicit keywords, etc.), and/or the text of the resource (e.g., the content of a webpage or document). Raw keyword data 310 may be received in real time, as the keyword activity records are generated, or periodically (e.g., hourly, daily, at irregular intervals, after a certain amount of raw keyword data 310 has been generated, when requested, etc.). Raw keyword data 310 may be an extremely large and noisy dataset, received at a high rate, for example, with millions of rows per day, including a large variety of relevant and irrelevant keywords.

In subprocess 312, raw keyword data 310 is processed to produce active keywords 314. Subprocess 312 may comprise parsing raw keyword data 310 to extract keywords in the online resource and/or keywords in the metadata for the online resource. It should be understood that these keywords represent those keywords that are being recently or actively used in search queries, seen in online resources that have recently been visited or with which visitors are otherwise engaging, and/or the like. Subprocess 312 may parse out keywords in the text of an online resource (e.g., content of a webpage or other online document), as well as the keywords embedded in metadata for the resource. However, in an embodiment, subprocess 312 parses keywords embedded in the metadata of the online resource, but not in the text of the online resource. The metadata may comprise an array of keywords that are embedded in the online resource for search engine optimization (SEO), extracted by machine learning (e.g., Watson Natural Language Understanding provided by International Business Machines Corp. of Armonk, N.Y.), and/or the like.

In addition, subprocess 312 may comprise processing the URLs in raw keyword data 310 to extract additional keywords from the URLs themselves. For example, each URL may be processed via string manipulation to extract usable keywords. Separator or delimiter symbols that frequently occur in URLs, such as “/”, “-”, “_”, and “.”, may be used to split the URL into its component keywords. For example, the URL “hub. 6sense.com/blogs/6sense-linkedin-ads-better-targeting-bigger-engagement” may be parsed into the keywords [6sense, linkedin, ads, better, targeting, bigger, engagement] by separating the character string after the last delimiter “/” based on the delimiter “-”. It should be understood that URLs typically follow a few common and well-known patterns, and that these patterns may be used to separate the URLs into keywords, which are added to active keywords 314.

All of the active keywords 314 extracted from a particular one of the keyword activity records in raw keyword data 310 may be stored in a single array for that keyword activity record. In other words, there may be a one-to-one correspondence between the plurality of keyword activity records in raw keyword data 310 and a plurality of arrays of keywords in active keywords 314. For example, active keywords 314 may comprise, for each online resource, an array of keywords extracted from the online resource, such as keyword(s) from the metadata of the online resource (e.g., title, description, explicit keywords, etc.), keyword(s) from the URL of the online resource, keyword(s) extracted by machine learning (e.g., Watson Natural Language Understanding), and/or the like. It should be understood that the array of keywords could include keyword(s) from the text of the online resource itself, in embodiments which parse the text of the online resource itself to extract keywords. Each array of keywords in active keywords 314 may be associated with the URL (or other identifier) of the online resource represented by the keyword activity record from which that array was extracted. In other words, the associations or relationships between the arrays of keywords and their corresponding URLs may be maintained during process 300 for utilization in one or more downstream functions.

One or a plurality of user-specified keywords 320 may be specified by a user. The user may be a user of a business account with platform 110. For example, an enterprise may establish a business account with platform 110 via standard registration techniques, and may create one or more user accounts to be used by users within that business account. Alternatively, each business account may have a single user, in which case, the business account and user account are one in the same. In any case, each user, when logged into his or her corresponding user account on platform 110, may specify one or more keywords 320 via a graphical user interface provided by the disclosed application. For example, the graphical user interface may comprise one or more screens with one or more inputs for inputting and submitting keywords of interest (e.g., relevant to the user's business and/or products). Alternatively, platform 110 may provide an API, and users may submit keywords of interest via the API.

In an embodiment, the user may specify, for each keyword that is input, whether the keyword is a branded or generic keyword. Alternatively, the application may automatically determine whether each keyword that the user inputs is branded or generic, for example, by performing a lookup of the keyword in a database of branded keywords, determining that the keyword is branded when it appears in the database, and determining that the keyword is generic when it does not appear in the database. It should be understood that a branded keyword is one that identifies a particular company or product (e.g., company name, product name, trademark, etc.), whereas a generic keyword is one that does not identify a particular company or product. The classification of a keyword as branded or generic may be useful for one or more downstream functions. For example, a branded keyword may be given more weight in a predictive model that predicts a prospective purchaser's intent, since a branded keyword may suggest that the prospective purchaser is further along in the purchasing process than a generic keyword.

In subprocess 330, active keywords 314, extracted from raw keyword data 310, are matched to user-specified keywords 320. In particular, each array of keywords in active keywords 314 is compared to each keyword in user-specified keywords 320. Each array of keywords in active keywords 314 that is matched to a keyword in user-specified keywords 320 is output by subprocess 330 to produce a set of filtered keywords 340. In other words, filtered keywords 340 comprises the arrays of keywords from active keywords 314 that match at least one of user-specified keywords 320. It should be understood that each of these arrays of keywords in filtered keywords 340 represents a single online resource, as represented by a URL and represented by a keyword activity record in raw keyword data 310. Thus, filtered keywords 340 can also be thought of as a list of online resources that are relevant to user-specified keywords 320 and which are represented as arrays of keywords.

The matching may comprise both exact keyword matching and array intersect matching. In exact keyword matching, a user-specified keyword 320 is matched to an identical keyword 314 in an array of keywords associated with an online resource. For example, the term [cloud] in user-specified keywords 320 exactly matches an array of keywords of [azure, oracle, cloud, computing]. In array intersect matching, a user-specified keyword that comprises a multi-word phrase is matched to an array of keywords which comprises the words in the multi-word phrase, even if the array does not comprise the exact multi-word phrase. Optionally, the multi-word phrase may match to an array of keywords regardless of the arrangement of the words from the multi-word phrase within the array of keywords. For example, the term [predictive analytics] in user-specified keywords 320 matches an array of keywords of [predictive, cloud, analytics, marketing], and optionally, matches an array of keywords of [cloud, analytics, marketing, predictive]. Alternatively, the multi-word phrase may match to an array of keywords only if the words in the multi-word phrase occur in the same order within the array of keywords. In this case, the term [predictive analytics] in user-specified keywords 320 would match an array of keywords of [predictive, cloud, analytics, marketing], but would not match an array of keywords of [cloud, analytics, marketing, predictive]. In any case, if the array of keywords for an online resource comprises all of the words in the multi-word phrase (or, alternatively, at least a significant percentage of the words in the multi-word phrase), the array is matched to the multi-word phrase even though the array does not contain the exact multi-word phrase.

As mentioned above, filtered keywords 340 may consist of the arrays of keywords 314, representing online resources in raw keyword data 310, that were matched to user-specified keywords 320 in subprocess 330. Thus, it should be understood that filtered keywords 340 may be different for different users, since user-specified keywords 320 will typically be different for different users. In other words, there may be a plurality of different sets of user-specified keywords 320 as specified by different users, and keyword matching subprocess 330 may be performed on each of the plurality of different sets of user-specified keywords to produce a plurality of different sets of filtered keywords 340 for each user. In other words, each set of filtered keywords 340 is user-specific.

In an embodiment, filtered keywords 340 are used to train a keyword model 350. Specifically, a training dataset may be generated from filtered keywords 340, and keyword model 350 may be trained on the training dataset to accept a keyword and output one or more related or recommended keywords. Advantageously, since filtered keywords 340 have already been filtered to exclude keywords that are not relevant to users, the relevance of the training dataset to the users is ensured. For example, for B2B users, virtually all of filtered keywords 340 will be relevant to B2B. Thus, the use of filtered keywords 340 to train keyword model 350, which may comprise a machine-learning algorithm, ensures that the resulting keyword model 350 is relevant to the users' business. In an embodiment, a distinct keyword model 350 may be trained, stored, and operated for each user, such that different keyword models 350 are associated with different users. In other words, distinct sets of user-specified filtered keywords 340 may be used to train distinct keyword models 350 for each user. Alternatively, the same keyword model 350 may be used for all users, or for groups of users in the same industry or who share some other relevant characteristic(s).

Keyword model 350 may comprise or otherwise be based on the word2vec algorithm. Word2vec uses a neural network to learn word associations from a corpus of text, so that it can detect synonyms of the input keyword or suggest additional keywords to be used with the input keyword (e.g., in a partial sentence). Word2vec represents each distinct word with a vector of numbers, such that a mathematical function (e.g., cosine similarity) can be applied to two vectors to indicate the level of semantic similarity between the two words represented by those two vectors. In particular, word2vec uses a group of shallow, two-layer neural networks that are trained using the training dataset to reconstruct linguistic contexts of words using a vector space that is typically hundreds of dimensions. Each word in the training dataset is assigned a corresponding vector in the vector space, such that words that share common contexts in the training dataset are located close to each other in the vector space.

After the training phase, in which keyword model 350 is trained, keyword model 350 may be deployed to recommend keywords in an operation phase. For example, in the operation phase, keyword model 350 may receive user-specified keywords 320 as input, and output recommended keywords 352. For example, whenever a user inputs keywords 320, the application may automatically (e.g., without any user intervention) or semi-automatically (e.g., after user confirmation to proceed) apply keyword model 350 to generate recommended keywords 320. Alternatively, the application may provide a dedicated screen, frame, or input in the graphical user interface that enables a user to manually input keywords 320 to produce recommended keywords 352.

The application may display recommended keywords 352 in the graphical user interface, along with one or more inputs that enable the user to individually and/or collectively select one or more of recommended keywords 352 to be added to user-specified keywords 320. Alternatively, the application may automatically add recommended keywords 352 to user-specified keywords 320. In either case, it should be understood that the recommended keywords 352 that are added to user-specified keywords 320 are used for keyword matching in subprocess 330. Thus, advantageously, keyword model 350 provides artificial intelligence, that has been trained on a dataset that is implicitly relevant to the user and/or the user's business (e.g., inferred from prior filtered keywords 340), to enhance and improve the keyword matching in subprocess 330.

Filtered keywords 340 may be used in one or more downstream functions, such as for reporting 360, to rank URLs in subprocess 370 for one or more predictive models 380, and/or for one or more other processes or models. Reporting 360 may be performed by server application 112 of platform 110 or a separate platform. In either case, reporting 360 may be performed via an account-based marketing (ABM) platform that enables users to view aggregated and/or company-level profile and behavioral information that is relevant to filtered keywords 340. For example, the ABM platform may provide the user with various metrics and reporting capabilities around intent signals, derived from filtered keywords 340, through a graphical user interface.

In subprocess 370, ranking logic may be applied to assess and rank the relevance to a given user of each URL, represented by an array of keywords in filtered keywords 340, relative to every other URL represented in filtered keywords 340. The rankings of the URLs, by the ranking logic, may be a function of one or more metrics of filtered keywords 340. For example, these metrics may include, without limitation, the number of matching keywords in the array of keywords for a URL and/or the overall frequency of the keywords in the array of keywords for the URL relative to filtered keywords 340.

The ranked URLs from subprocess 370 may be provided to one or more predictive models 380, such as the predictive models disclosed in the '227 patent and the '056 patent. For example, a predictive model 380 may predict the purchase intent of a company, indicating a likelihood that the company will purchase a product (e.g., good or service) that the user sells. In this case, predictive model 380 may aggregate engagement behavior by a company (e.g., online activities, such as search queries, website visits, web form submissions, opening an email, replying to an email, downloading an electronic document, etc., as well as offline activities, such as attending a trade show, visiting a store, etc.), collected from one or more data sources (e.g., sales or marketing campaigns, websites, search engines, etc.), and output a score indicating the company's likelihood to purchase the product. Engagement behavior may be associated with specific companies using a mapping service that identifies the company associated with an access of an online resource (e.g., based on the IP address, domain name, account sign-in, etc., in the keyword activity records). The ranked URLs may be used to generate one or more weights used by predictive model 380. For example, engagements (e.g., visits) with a higher ranked URL may be weighted higher, in predictive model 380, than engagements with a lower ranked URL. Thus, a company's visit to a higher ranked URL may increase the score, output by predictive model 380 for the company, relative to a visit to a lower ranked URL.

In an embodiment, predictive model 380 may also weight engagements based on the use of generic or branded keywords. For example, an engagement comprising a search for branded keywords may be weighted higher than an engagement comprising a search for generic keywords. Thus, a company's use of a branded keyword at a URL (e.g., search engine, website, etc.) may increase the score, output by predictive model 380 for the company, relative to a use of a generic keyword at the URL. In other words, predictive model 380 infers that a company which is using branded keywords is further along in the buying process than a company which is using generic keywords, because branded keywords indicate more targeted research behavior.

2.2. Array Intersect Matching

The highest quality keywords for determining B2B purchase intent are often multi-word phrases, since these represent more targeted research behavior. Thus, in an embodiment, subprocess 330 utilizes array intersect matching to glean such phrases from active keywords 314. This array intersect matching may be implemented as a user-defined function that is able to match a user-specified multi-word phrase to an array of keywords, representing a URL, based on the presence of the phrase's component words in the array of keywords, regardless of how those component words are arranged in the array of keywords. The function may implement this by receiving the multi-word phrase (e.g., “account based marketing”), splitting (e.g., based on spaces) the multi-word phrase into an array of words (e.g., [account, based, marketing]), and then searching for an intersection of that array of words in the arrays of keywords in active keywords 314.

2.3. Keyword Recommendation

As discussed above, keyword model 350 is trained using filtered keywords 340 to provide recommended keywords 352 based on an input of user-specified keywords 320. Thus, keyword model 350 increases the volume of keywords in the data pipeline of process 300. Notably, this is in addition to the processing of URLs in subprocess 312, which also increases the volume of keywords in the data pipeline of process 300. Advantageously, this increase in the volume of keywords provides additional sources of signals for downstream functions, such as predictive model(s) 380 (e.g., intent signals for a predictive intent model). It should be understood that keyword recommendations may be used for a number of other downstream functions, such as to automatically generate initial keywords for a new user (e.g., a cold start that automatically generates keywords based on the new user's business), score the relevance of a potential new keyword (e.g., based on a similarity distance in the vector space of keyword model 350 to known relevant keywords) for SEM or other purposes, and/or score data for URLs to judge the relevance a predictive model 380 would assign to them for SEO or other purposes.

The keyword recommendations may be integrated into the graphical user interface of the application as a tool for keyword research. A user can input user-specified keywords 320 into the graphical user interface to generate recommended keywords 352 from keyword model 350. As discussed above, keyword model 350 may be trained on filtered keywords 340. These features ensure that recommended keywords 352 are both specific to the user and tailored to the user's business (e.g., B2B).

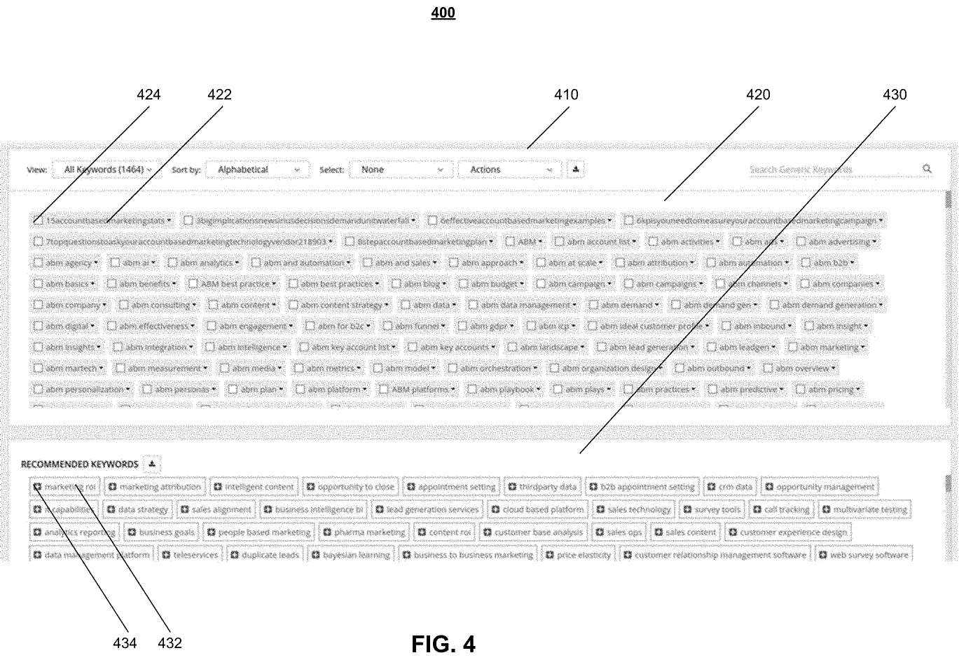

FIG. 4 illustrates an example of a screen 400 (e.g., webpage) of a graphical user interface for providing recommended keywords 352, according to an embodiment. As illustrated, screen 400 comprises one or more inputs 410 for selecting, sorting, searching, and/or performing actions on subsets of user-specified keywords 320 (e.g., branded, generic, user-created subsets related to specific spaces, etc.), a frame 420 for user-specified keywords 320, and a frame 430 for recommended keywords 352.

Frame 420 represents each of user-specified keywords 320, in the selected subset, sorted according to the selected sort criterion (e.g., alphabetical). Each user-specified keyword 320 may be represented as a visual element 422 which comprises the keyword as text and an input 424 (e.g., checkbox). A user may select input 424 of a particular visual element 422 to select the keyword represented by that visual element 422. The user may select one or a plurality of keywords, in this manner, using the respective inputs 424 for the keyword(s), and collectively perform an action (e.g., delete) on all of the selected keyword(s) (e.g., using one of inputs 410).

Frame 430 lists the recommended keywords 352 that are output by keyword model 350 after it has been applied to the user-specified keywords 320 in frame 420. Each recommended keyword 352 may be represented as a visual element 432 which comprises the keyword as text and an input 434 (e.g., “plus” icon). A user may select input 434 of a particular visual element 432 to add the keyword represented by that visual element 432 to user-specified keywords 320. In other words, if the user selects input 434 of a particular visual element 432, that visual element 432 may be removed from frame 430, and a corresponding visual element 422 may be added to frame 420. It should be understood that the corresponding visual element 422 that is added to frame 420 will comprise the keyword as text and an input 424 for selecting the keyword, just like the visual elements 422 for all other user-specified keywords 320 in frame 420. In addition, the application may automatically apply keyword model 350 to these user-added recommended keyword(s) 352 to produce one or more new recommended keywords 352, which can be visually represented by visual element(s) 432 in frame 430. In this manner, a user can quickly and easily build a large set of relevant user-specified keywords 320.

2.4. Word2vec

As discussed above, keyword model 350 may comprise the word2vec algorithm, trained on publisher data comprising arrays of keywords (e.g., metadata keywords), to provide word associations output as recommended keywords 352. Word2vec converts each word into a vector representation that can be used to find lists of similar words or provide a similarity score when comparing two words (i.e., comparing two vector representations of the two words). Implementations of word2vec exist in machine-learning libraries in Python™, including Gensim and H2O. In a particular implementation, the Gensim library was used to build the word2vec algorithm for keyword model 350.

Word2vec uses a document approach to learn word correlations. A multi-dimensional vector is built using the frequencies of word co-occurrences in documents in the training dataset. Several word2vec algorithms exist in the public domain, including one (code.google.com/archive/p/word2vec/) released by Google™ of Mountain View, Calif., that was trained on news articles. However, there are large drawbacks to using a prebuilt model to make keyword recommendations.

For example, while these prebuilt models (e.g., trained on a corpus of news articles) may be useful for single words, their vocabularies do not include multi-word phrases (e.g., “account based marketing”) which can be especially useful for inferring intent. The ability to identify multi-word keyword phrases, sometimes referred to as “n-grams,” is important for B2B research, since they provide much more targeted, and therefore relevant, results. Thus, in an embodiment, to account for n-grams, keyword model 350 uses keyword arrays from metadata of URLs (e.g., including the URLs themselves) as the “documents” used to train the word2vec algorithm. Advantageously, the use of metadata keyword arrays as “documents” (e.g., as opposed to actual documents, such as news articles), provides the word2vec algorithm with predefined n-grams and co-occurrence relationships.

Another drawback to using a large, arbitrary dataset for training the word2vec algorithm is that many words and phrases are context-dependent. Their meanings may be different in the B2B context than in the general context. As an example, in a general English-language context, the word “cloud” is associated with words such as “weather,” “rain,” “cumulus,” and the like. However, in the B2B context, the word “cloud” should be associated with words such as “azure,” “oracle,” “cloud computing,” and the like. Some of these words are brand names and others are more general English-language words. Advantageously, the word2vec algorithm of keyword model 350, trained using filtered keywords 340, will produce words that are relevant to the user's specific context (e.g., B2B uses of “cloud”), since it will generally not be trained on words that are not relevant to the user's specific context (e.g., weather-related uses of “cloud”).

In other words, the training dataset for keyword model 350 is highly filtered to ensure its relevance to the user's specific context (e.g., B2B). Specifically, the training dataset comes from filtered keywords 340, instead of directly from raw keyword data 310 or some other broad corpus. Essentially, users implicitly (and potentially unknowingly) build the training dataset by manually entering user-specified keywords 320. From the users' perspectives, they are simply entering user-specified keywords 320 that they believe are relevant to downstream functions, such as predictive models 380. However, the application also repurposes these user-specified keywords 320, which represent a broad corpus (e.g., URLs) with most irrelevant keywords filtered out, as training datasets for keyword model 350. These improves the efficiency of the training process, reduces the memory requirements of the training process, and results in the vocabulary of keyword model 350 being tailored to the users' specific contexts (e.g., B2B).

2.5. Training

As discussed above, the training dataset for keyword model 350 comes from publisher data (i.e., raw keyword data 310) that is processed (e.g., in subprocess 312) and filtered (e.g., in subprocess 330) such that it only contains arrays of keywords that match user-specified keywords 320 (e.g., exactly or via array intersect). Filtered keywords 340 are the output of the matching in subprocess 330, and comprise the matched arrays of keywords that are incorporated into or used as the training dataset. The data processing and filtering processes (e.g., subprocesses 312 and 330) may be part of a daily or other periodic extract, transform, load (ETL) pipeline that continually processes raw keyword data 310 and matches active keywords 314 against user-specified keywords 320 to produce filtered keywords 340.

While filtered keywords 340 are used for downstream functions, such as reporting 360 and predictive models 380, they may also be re-purposed as training datasets for keyword model 350, which may comprise the word2vec algorithm. Advantageously, since the training datasets consist of already filtered and targeted keywords (representing filtered and targeted URLs), keyword model 350 may be trained to generate highly relevant results with less training data than would otherwise be required. This greatly improves the relevance of the model's output to the user's specific context (e.g., B2B), relative to a model that is trained on the whole corpus of URLs.

Some examples of the arrays of keywords in filtered keywords 340 are provided below:
1: [business news, financial news, stock market quotes, market news, stock market news, personal finance news, stock information, stock]
2: [market, stocks, finance, mutual funds, etfs, oil, gold, silver, gas, business]
3: [nvidia, driver, drivers, download, software, geforce, quadro, tesla, nforce]
4: [business email, project management software, accounting software, life insurance, financial advisor, online stock trader, stock trading, cut url, cut urls, earn money, short links, short link service, best shortening links]
5: [solar, pv, renewables, modules, cells, tariffs, news, blogs, analysis]

It should be understood that each array of keywords represents a single URL and is considered one document in the training dataset. Notably, the arrays comprise both keywords consisting of a single word and keywords comprising multi-word phrases. In addition, the arrays may comprise both branded keywords and generic keywords.

In an embodiment, the application may pre-process the arrays of keywords in filtered keywords 340 before adding the arrays of keywords to the training dataset. This pre-processing may comprise normalizing the keywords (e.g., by removing spaces) in the arrays. When normalizing the keywords, the application may generate a look-up dictionary that associates the normalized version of each of the keywords to its corresponding un-normalized version (e.g., mapping the normalized “accountbasedmarketing” to the un-normalized “account based marketing”). The look-up dictionary enables the graphical user interface to display the un-normalized keywords in place of the normalized keywords, since the un-normalized keywords will generally be easier to read and understand by a human. In addition, the pre-processing may comprise removing offensive words that are not relevant to the user's specific context (e.g., B2B), for example, using a predefined look-up dictionary of offensive words.

Keyword model 350 may be trained using these pre-processed arrays of keywords (i.e., “documents”) in the training dataset using standard parameters. For example, in an embodiment which utilizes the word2vec algorithm for keyword model 350, the word2vec algorithm may be trained using, for example, a 100-dimensional vector space, a relevancy window of 10, and a minimum occurrence threshold of 5:

model=Word2Vec(documents, size=100, window=10, min_count=5, workers=8)

model.train(documents, total examples=len(documents), epochs=1)

model.save_word2vec_format(‘model_name_version.bin’, binary=true)

2.6. Operation

In an embodiment which utilizes the word2vec algorithm in keyword model 350, recommended keywords 352 may be generated using the Gensim library's “most similar” function. The “most similar” function accepts a word or array of words as input, and generates a list of words that are ranked by a similarity score. The similarity score is determined using Euclidean distance in the embedded vector space that was created during training of the word2vec algorithm. In this case, the output of keyword model 350 may comprise a list, in which each entry comprises a keyword and a similarity score representing that keyword's similarity to the input keyword (e.g., with a higher score representing greater similarity, and a lower score representing lower similarity). Some examples of the inputs and outputs of a trained word2vec algorithm are provided below:

```
: model.wv.most_similar(‘business’)
: [(‘commerce’, 0.5051543712615967),
  (‘businesses’, 0.4964611530303955),
  (‘company’, 0.4873649775981903),
  (‘small business’, 0.46376699209213257),
  (‘profit’, 0.4615456461906433),
  (‘award’, 0.4571419060230255),
  (‘franchise’, 0.45397913455963135),
  (‘industry’, 0.4539056122303009),
  (‘profession’, 0.4519237279891968),
  (‘technology’, 0.4380800724029541)]
: model.wv.most_similar(‘predictive analytics’)
: [(‘data mining’, 0.931482195854187),
  (‘predictive modeling’, 0.9308880567550659),
  (‘business analytics’, 0.905793309211731),
  (‘business strategy’, 0.9040995240211487),
  (‘big data analytics’, 0.9005128145217896),
  (‘data analytics’, 0.8995591402053833),
  (‘data quality’, 0.8967177271842957),
  (‘data integration’, 0.8917843103408813),
  (‘digital technologies’, 0.8888974189758301),
  (‘erm’, 0.8869186043739319)]
: model.wv.most_similar (positive=[‘predictive analytics’,
‘marketing intelligence’, ‘marketing analytics’])
: [(‘ab testing’, 0.9416207075119019),
  (‘market intelligence’, 0.931481659412384),
  (‘data warehouse’, 0.9212490320205688),
  (‘advanced analytics’, 0.9202632904052734),
  (‘unstructured data’, 0.9168689846992493),
  (‘data services’, 0.9152300357818604),
  (‘marketing research’, 0.9139900207519531),
  (‘account based marketing’, 0.912448525428772),
  (‘resource allocation’, 0.9121400713920593),
  (‘dynamic programming’, 0.9120453000068665)]
```

In an embodiment, a set of one or more negative keywords may also be provided as input into keyword model 350. In this case, a negative keyword would have a negative influence on recommendations. For example, the score of a given word may decrease as its distance to a negative keyword in the vector space decreases.

In an embodiment, only those keywords, output by keyword model 350 for a given input keyword, for which the similarity score satisfies a predefined threshold (e.g., greater than or equal to 0.90 or 90% similarity) may be included in recommended keywords 352. Keywords for which the similarity score does not satisfy the predefined threshold may be excluded from recommended keywords 352. Alternatively or additionally, a predefined number (e.g., three, five, ten, etc.) of keywords with the highest similarity scores for a given input keyword may be included in recommended keywords 352, whereas keywords outside this predefined number may be excluded from recommended keywords 352.

In an embodiment, the trained keyword model 350 may be stored in cloud storage, such as Amazon Simple Storage Service (S3). The binary code of keyword model 350 may be loaded, as needed, and fed user-specified keywords 320 that are input through the graphical user interface of the application. All recommended keywords 352, output by keyword model 350, that have a similarity score that is equal to or greater than a predefined threshold score (e.g., 0.9) may be provided to the user via the graphical user interface. The look-up dictionary, generated during pre-processing, that maps normalized versions of keywords to un-normalized versions of keywords, may be used to convert the normalized versions of keywords 352 in the raw output of keyword model 350 to un-normalized versions of keywords 352 for presentation in the graphical user interface. Recommended keywords 352, output by keyword model 350, that have a similarity score that is less than the predefined threshold score are not provided to the user (e.g., excluded from presentation in the graphical user interface).

2.7. Downstream Functions

It should be understood that each array of keywords in filtered keywords 340 and the training dataset represents a URL. For example, each array of keywords represents the metadata keywords (e.g., in explicit metadata and character strings in the URL itself) that were extracted from a keyword activity record, comprising a URL, in raw keyword data 310. Additionally or alternatively, each array of keywords may represent keywords from the content of the online resource at the URL. Each array of keywords in filtered keywords 340 may be associated with the corresponding URL in the keyword activity record from which that array of keywords was extracted. Each URL represents an engagement between the online resource at the URL and a visitor to that online resource, and may be associated with an IP address and/or domain name (e.g., in raw keyword data 310), representing the network address or source of the visitor, and a timestamp representing the date and time of the visit. In an embodiment, the IP address and/or domain name may be mapped to a specific company using an IP-to-company mapping or domain-name-to-company mapping. Examples of such mappings are described in the '427 patent. In other words, keyword research and other online research, represented as engagements with the URLs, may be linked to specific companies, which may be represented as specific accounts in a user's system (e.g., customer relationship management (CRM) system, marketing automation platform (MAP), etc.).

Notably, since filtered keywords 340 consist of mostly relevant arrays of keywords, the URLs that those arrays of keywords represent also consist of mostly relevant URLs. Each relevant URL represents a relevant engagement or activity (e.g., keyword search, website visit, etc.). Consequently, subprocess 330 not only filters irrelevant keywords, but also filters irrelevant activities. Thus, primarily relevant activities are provided to downstream functions (e.g., reporting 360, predictive models 380, etc.), thereby increasing downstream efficiency and effectiveness.

Of course, some irrelevant activities may survive subprocess 330, such that their corresponding arrays of keywords are present in filtered keywords 340. Irrelevant activities may comprise a visit or other engagement with a URL that concerns a topic that is irrelevant to a user's specific context (e.g., B2B). For example, when a user inputs “cloud” as a user-specified keyword 320 related to cloud computing, URLs related to weather may survive subprocess 330. Thus, in an embodiment, subprocess 370 acts as an additional filter to filter URLs based on one or more criteria developed around the number and/or frequency of matched keywords. For example, the criteria may comprise the average frequency of keywords and/or the fraction of matched keywords.

The average frequency of keywords may be computed for a URL by calculating the frequency of each keyword in the array of keywords representing the URL (e.g., in filtered keywords 340) relative to the entire corpus (e.g., active keywords 314, or filtered keywords 340), and then calculating the average frequency of keywords included in the array of keywords representing the URL. As an example, assume that a URL is represented by an array of keywords [cloud, cloud computing, azure], and that “cloud” has a population frequency of 0.1, “clouding computing” has a population frequency of 0.01, and “azure” has a population frequency of 0.05. In this case, the average frequency of keywords for the URL can be calculated as (0.1+0.01+0.05)/3=0.0387=3.9%.

The fraction of matched keywords for a URL may be computed as the fraction of keywords in the array of keywords representing the URL that match user-specified keywords 320. As an example, assume that a URL is represented by an array of keywords [cloud, cloud computing, azure], and that “cloud” has a population frequency of 0.1, “clouding computing” has a population frequency of 0.01, and “azure” has a population frequency of 0.05. Also, assume that user-specified keywords 320 only consists of the keyword “cloud computing.” In this case, the fraction of matched keywords for the URL can be calculated as ⅓=0.33=33%.

In an embodiment of subprocess 370, relevant URLs are defined as those having a fraction of matched keywords of at least 10% (i.e., at least 10% of the keywords in the array of keywords representing the URL must match keyword(s) in user-specified keywords 320), and an average frequency of keywords less than four times the overall average frequency for all keywords (i.e., on average, the keywords in the array of keywords representing the URL are four times less common than the overall average for any arbitrary keyword). These threshold were determined heuristically for one implementation. It should be understood that alternative definitions of relevance may be defined for other implementations.

Keyword intent activities, represented by the URLs associated with the arrays of keywords in filtered keywords 340 (e.g., as further filtered by subprocess 370), can be input, along with first-party datasets (e.g., representing engagements with sales and/or marketing campaigns, website visits and/or other website activities, etc.), to a predictive model 380 to generate an indication of purchase intent (e.g., a purchase intent score representing the likelihood of a purchase). Predictive model 380 may be applied to sets of URLs that have been mapped to particular companies (e.g., via an IP-to-company mapping). For instance, the plurality of keyword activity records in raw keyword data 310 that correspond to the relevant URLs output by subprocess 370 may be mapped to their corresponding companies, and predictive model 380 may be applied to the relevant URLs for each company to produce a purchase intent score for the company.

As an example, similar to clicking a link in a marketing email or attending a marketing event, a keyword research activity (e.g., a company searching for a keyword using an online search engine, as represented by a URL) indicates a purchase intent. However, a keyword research activity tends to indicate less of an intent than clicking a link or attending an event. Thus, a keyword research activity identifies companies in the early stage (upper funnel) of the purchasing process. Therefore, a keyword research activity may contribute a smaller amount to the purchase intent score than an activity that identifies companies in later stages (lower funnel) of the purchase processing (e.g., clicking a link in a marketing email, attending a marketing event, etc.).

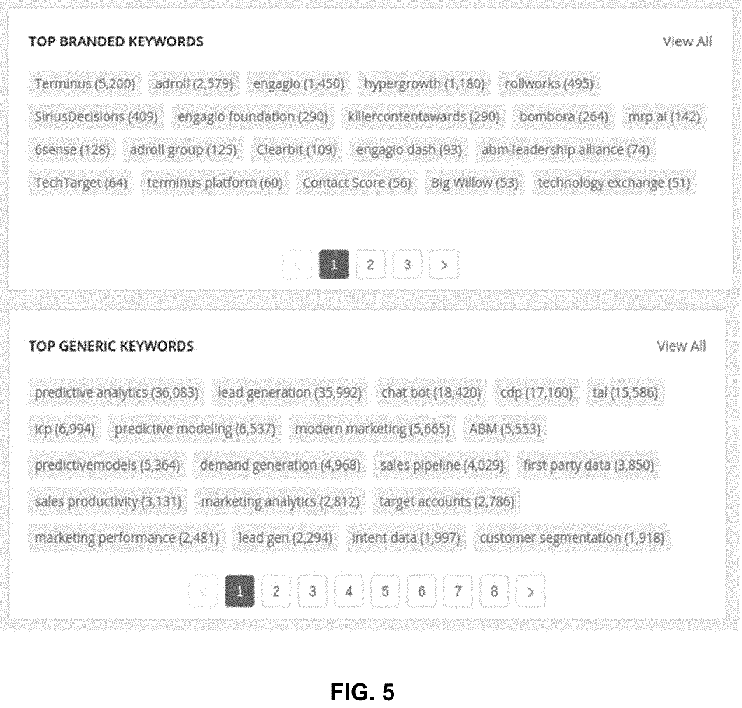

Reporting 360 may comprise a graphical user interface that provides useful keyword-related information and/or metrics to a user. For example, a screen of the graphical user interface may provide a list of the top keywords being used (e.g., in URL engagements represented in raw keyword data 310) in the user's specific context (e.g., B2B). FIG. 5 illustrates an example of a screen of the graphical user interface for providing top keywords, according to an embodiment. The top keywords may be separated into branded keywords and generic keywords, and the most frequent keywords (e.g., measured as the number of unique companies using the keyword, the number of total occurrences, and/or the like) in each category may be provided in descending order of frequency. As illustrated, each keyword may be visually represented as text along with a parenthetical number representing the number of unique companies researching the keyword. A look-up dictionary, as described elsewhere herein, may be used to convert un-normalized versions of the keywords into normalized versions of the keywords, prior to presentation in the graphical user interface. A user may utilize this data about the top keywords for segmentation or targeting in its marketing strategy (e.g., SEM, SEO of the user's website, targeted advertisements, etc.).

In an embodiment, keywords could be ranked based on conversion rates. For example, the conversions of companies (i.e., successful purchase transactions by the companies) may be analyzed to determine which keywords those companies were using prior to their conversions. This analysis can be used to rank keywords, for example, based on how frequently they were being used by these companies prior to those companies' conversions. It can be inferred that a keyword that occurs more frequently than another keyword is more effective at attracting business and/or predictive of a sale. Thus, such a keyword is a good candidate for use (e.g., in a website, purchased from a search engine, etc.) by a user seeking to improve its SEM and/or SEO. This frequency information can also be used to improve predictive models 380, such as a predictive intent model, for example, by increasing the weights for activities that comprise more predictive keywords (e.g., more frequently occurring in activities leading up to a successful conversion) over activities that comprise less predictive keywords (e.g., less frequently occurring in activities leading up to a successful conversion).

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive raw keyword data comprising a plurality of keyword activity records, wherein each of the plurality of keyword activity records comprises a uniform resource locator (URL) for an online resource and metadata for the online resource;
generate a plurality of arrays of keywords by extracting an array of keywords from each of the plurality of keyword activity records, wherein each of the plurality of arrays of keywords is associated with the URL in the keyword activity record from which the array of keywords was extracted;
receive one or more user-specified keywords;
identify a subset of the plurality of arrays of keywords that match at least one of the one or more user-specified keywords;
generate a training dataset from the subset of the plurality of arrays of keywords; and
use the training dataset to train a machine-learning model to output recommended keywords based on an input keyword.

2. The method of claim 1, wherein training the machine-learning model comprises training one or more neural networks to convert keywords in the training dataset to points in a multi-dimensional vector space in which a distance between two points represents a degree of similarity between keywords at those two points, such that a shorter distance represents a higher degree of similarity and a larger distance represents a lower degree of similarity.

3. The method of claim 2, wherein each point comprises a vector of numbers.

4. The method of claim 3, wherein the distance is a Euclidean distance.

5. The method of claim 2, wherein the multi-dimensional vector space comprises at least one-hundred dimensions.

6. The method of claim 1, wherein identifying a subset of the plurality of arrays of keywords that match at least one of the one or more user-specified keywords comprises, for each of the plurality of arrays of keywords and for each of the one or more user-specified keywords:
comparing the array of keywords to the user-specified keyword;
when the array of keywords comprises the user-specified keyword, determining that the array of keywords matches the user-specified keyword; and,
when the array of keywords does not comprise the user-specified keyword,
when the user-specified keyword comprises two or more words and the array of keywords comprises all of the two or more words, determining that the array of keywords matches the user-specified keyword regardless of an arrangement of the two or more words in the array of keywords, and,
when the user-specified keyword consists of a single word or when the user-specified keywords comprises two or more words and the array of keywords does not comprise all of the two or more words, determining that the array of keywords does not match the user-specified keyword.

7. The method of claim 1, wherein extracting an array of keywords from each of the plurality of keyword activity records comprises, for each of the plurality of keyword activity records, extracting one or more keywords from the metadata in the keyword activity record.

8. The method of claim 7, wherein extracting an array of keywords from each of the plurality of keyword activity records further comprises, for each of the plurality of keyword activity records, extracting one or more keywords from the URL in the keyword activity record.

9. The method of claim 8, wherein extracting one or more keywords from the URL comprises splitting the URL into two or more keywords based on one or more delimiter symbols.

10. The method of claim 1, further comprising using the at least one hardware processor to:
receive at least one keyword from a user;
apply the machine-learning model to the at least one keyword to output one or more recommended keywords; and
provide the one or more recommended keywords to the user.

11. The method of claim 10, further comprising using the at least one hardware processor to:
receive a selection of at least one of the one or more recommended keywords from the user; and
add the selected at least one recommended keyword to the one or more user-specified keywords.

12. The method of claim 11, further comprising using the at least one hardware processor to:
generate a graphical user interface comprising at least one screen, wherein the at least one screen comprises a first frame comprising a visual representation of each of the one or more user-specified keywords, and a second frame comprising a selectable visual representation of each of the one or more recommended keywords; and
wherein receiving a selection of at least one of the one or more recommended keywords from the user comprises receiving a selection of the selectable visual representation of that at least one recommended keyword in the second frame; and
wherein adding the selected at least one recommended keyword to the one or more user-specified keywords comprises adding a visual representation of the at least one recommended keyword to the first frame.

13. The method of claim 1, wherein generating a training dataset from the subset of the plurality of arrays of keywords comprises normalizing one or more keywords in the subset of the plurality of arrays of keywords.

14. The method of claim 13, wherein normalizing one or more keywords comprises removing spaces from any keywords in the subset of the plurality of arrays of keywords that comprise multi-word phrases.

15. The method of claim 13, further comprising using the at least one hardware processor to, when normalizing the one or more keywords, generate a look-up dictionary that, for each of the normalized one or more keywords, maps a normalized version of that keyword to an un-normalized version of that keyword.

16. The method of claim 15, further comprising using the at least one hardware processor to:
apply the machine-learning model to at least one input keyword to output the normalized version of each of one or more recommended keywords;
use the look-up dictionary to retrieve the un-normalized version of each of the one or more recommended keywords; and
provide the un-normalized version of each of the one or more recommended keywords to a user.

17. The method of claim 1, further comprising using the at least one hardware processor to:
rank the URLs that are associated with the subset of the plurality of arrays of keywords based on, for each array of keywords in the subset of the plurality of arrays of keywords, an average frequency of keywords in that array of keywords, relative to a corpus, and a fraction of keywords in that array of keywords that matched at least one of the one or more user-specified keywords; and
determine a relevant subset of the URLs based on the ranking.

18. The method of claim 17, further comprising using the at least one hardware processor to:
associate each of the plurality of keyword activity records to a company that corresponds to a visit to the URL in that keyword activity record; and,
for each company that corresponds to a visit to one or more URLs in the relevant subset of the URLs, apply a predictive intent model to the one or more URLs to predict a likelihood that the company intends to purchase a product.

19. A system comprising:
at least one hardware processor; and
one or more software modules that are configured to, when executed by the at least one hardware processor,
receive raw keyword data comprising a plurality of keyword activity records, wherein each of the plurality of keyword activity records comprises a uniform resource locator (URL) for an online resource and metadata for the online resource,
generate a plurality of arrays of keywords by extracting an array of keywords from each of the plurality of keyword activity records, wherein each of the plurality of arrays of keywords is associated with the URL in the keyword activity record from which the array of keywords was extracted,
receive one or more user-specified keywords,
identify a subset of the plurality of arrays of keywords that match at least one of the one or more user-specified keywords,
generate a training dataset from the subset of the plurality of arrays of keywords, and
use the training dataset to train a machine-learning model to output recommended keywords based on an input keyword.

20. A non-transitory computer-readable medium having instructions stored therein, wherein the instructions, when executed by a processor, cause the processor to:
receive raw keyword data comprising a plurality of keyword activity records, wherein each of the plurality of keyword activity records comprises a uniform resource locator (URL) for an online resource and metadata for the online resource;
generate a plurality of arrays of keywords by extracting an array of keywords from each of the plurality of keyword activity records, wherein each of the plurality of arrays of keywords is associated with the URL in the keyword activity record from which the array of keywords was extracted;
receive one or more user-specified keywords;
identify a subset of the plurality of arrays of keywords that match at least one of the one or more user-specified keywords;
generate a training dataset from the subset of the plurality of arrays of keywords; and
use the training dataset to train a machine-learning model to output recommended keywords based on an input keyword.
